(19) United States
(12) Patent Application Publication
(10) Pub. No.: US 2004/0094857 A1
(43) Pub. Date: May 20, 2004

(54) Method for manufacturing molded products

(76) Inventors: Takayuki Ito, Aichi-ken (JP); Yoshiharu Tsutsui, Aichi-ken (JP)

Correspondence Address: POSZ & BETHARDS, PLC, 11250 ROGER BACON DRIVE, SUITE 10, RESTON, VA, 20190, US

(21) Appl. No.: 10/670,502

(22) Filed: Sep. 26, 2003

(30) Foreign Application Priority Data
Nov. 14, 2002 (JP) 2002-330372

(51) Int. Cl. B29C 44/12

(52) U.S. Cl. 264/46.7; 264/255; 264/259

(57) ABSTRACT

A method for manufacturing a molded product with an improved quality. A metal core is set at a predetermined position in a mold. Then, the mold is closed, a first liquid containing a releasing agent and a solvent is injected into the cavity, and the cavity is depressurized. This forms a uniform releasing agent layer on the wall surface of the cavity. Then, a mold-coat layer, which provides a surface layer of the molded product, is formed on the releasing agent layer, a molding material for forming a molding layer is injected in the cavity, and the mold is opened.

### BACKGROUND OF THE INVENTION

The present invention relates to a method for manufacturing molded products using a mold.

A layer of a resin, such as urethane resin, is applied to the rim of a vehicle steering wheel. A surface protective layer having light resistant property, or a so-called mold-coat layer, is superimposed over this resin layer.

In the steering wheel manufacturing process, the internal wall surface of the mold cavity is coated with a mold releasing agent to facilitate removal of a molded steering wheel subsequent to molding.

To apply the releasing agent, in a state in which the mold is opened, the internal wall surface of the mold cavity is sprayed with a solution containing the mold releasing agent (a first conventional method).

In a second conventional method for applying the releasing agent, when a metal core of a steering wheel is set in a mold, the mold is closed and the mold cavity is depressurized. In this state, a mold-coat liquid containing a releasing agent is injected into the mold cavity to apply a mold-coat layer, which contains the releasing agent, to the cavity wall (refer to, for example, Japanese Patent No. 2746024, page 5, FIGS. 11 and 12).

However, the first and second conventional methods have the shortcomings described below.

When performing the first conventional method, the solution containing the releasing agent sprayed by a spray gun readily adheres to parts other than the wall surface of the cavity, such as the parting surfaces of movable and fixed molds. This decreases the efficiency for applying the releasing agent.

If the mold is closed when the releasing agent is adhered to the mold parting surfaces near the cavity wall, some of the releasing agent adhered to the parting surface migrates into the cavity, due to the pressure produced when the mold is closed, and swells. Then, when forming the mold-coat layer and the resin layer with the swollen releasing agent in the cavity near the parting surfaces, the swollen part encroaches into the mold-coat layer and resin layer so as to produce so-called notching.

Further, the amount and distribution of the releasing agent applied with the spray gun varies depending on the skill of the worker performing the application. This may lead to uneven application of the releasing agent. When the releasing agent is applied unevenly, it becomes difficult to separate the molded steering wheel from the mold. This may cause irregular quality on the surface of the resin layer and mold-coat layer.

In order to ensure release from the mold by the releasing agent when performing the second conventional method, the releasing agent content of the mold-coat liquid is required to be greater than the amount used when simply applying only the releasing agent. When the mold-coat liquid containing the releasing agent contains a large amount of releasing agent, the adhesion of the resin layer and the mold-coat layer in the molded product is reduced, and the external surface of the molded product may have excessive luster. This would reduce the quality of the molded product.

### SUMMARY OF THE INVENTION

It is an object of the present invention to provide a method for manufacturing molded products that improves the quality of molded products and effectively forms a releasing agent layer in the mold.

To achieve the above object, the present invention provides a method for manufacturing a molded product having a molded portion. The method includes forming a releasing agent layer on a wall surface of a cavity of a mold by injecting a first liquid containing releasing agent into the cavity and depressurizing the cavity. The method also includes forming the molded portion by supplying molding material into the cavity after the releasing agent layer is formed.

A further aspect of the present invention is a method for manufacturing a molded product using a mold having a cavity. The method includes forming a releasing agent layer on entire surface of the cavity when the mold is closed and supplying molding material to the cavity after the releasing agent layer is formed to form the molded product.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a steering wheel according to a preferred embodiment of the present invention;

FIG. 2 is a cross-sectional view taken along line 2-2 in FIG. 1;

FIG. 3 is a schematic diagram showing a molding apparatus of the present invention;

FIG. 4 is a cross-sectional view showing a mold and a box of the molding apparatus; and

FIG. 5 is a flowchart illustrating the procedures for manufacturing the steering wheel.

### DESCRIPTION OF THE PREFERRED EMBODIMENTS

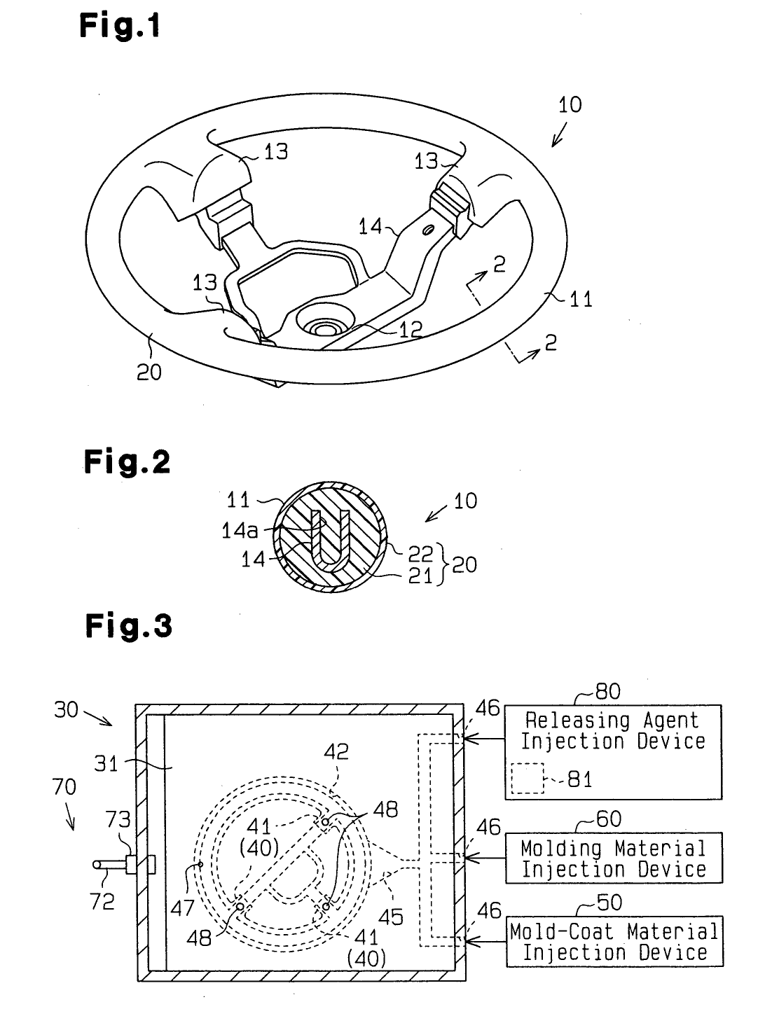

A method for manufacturing a molded product according to a preferred embodiment of the present invention will now be described with reference to FIGS. 1 through 5. In the preferred embodiment, a vehicle steering wheel is manufactured as the molded product.

As shown in FIG. 1, a steering wheel 10 has a ring 11, which functions as a grip, a boss 12, and a plurality of (three in the preferred embodiment) spokes 13, which connect the ring 11 and the boss 12. The steering wheel 10 includes a metal core 14, which is used as an insert. Portions of the metal core 14 corresponding to the ring 11 and portions of the metal core 14 corresponding to part of the spokes 13 are covered with a molding material, such as polyurethane (PUR), to form a molded portion 20.

As shown in FIG. 2, the molded portion 20 includes an internal molding layer 21, which is formed on the metal core 14, and a cover layer (mold-coat layer) 22, which is formed on the internal molding layer 21 and functions as a surface layer of the steering wheel 10. The cover layer 22 is formed from, for example, a material having light-resistant properties. Further, the cover layer 22 protects the internal molding layer 21 and improves the aesthetic appearance of the steering wheel 10. The steering wheel 10 is an insert molded product manufactured by performing insert molding with the metal core 14.

In the preferred embodiment, as shown in FIG. 2, the cross-section of the metal core 14 at the portion corresponding to the ring 11 is U-shaped so that a concave channel 14a extends along the metal core 14 at this portion.

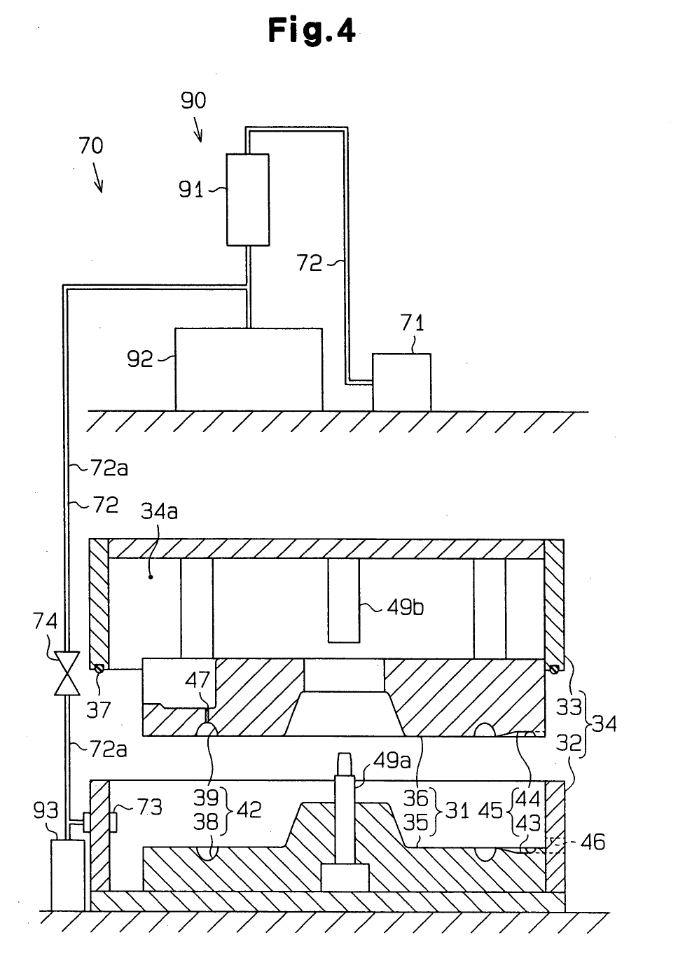

An apparatus 30 for insert molding the steering wheel 10 will now be described with reference to FIGS. 3 and 4.

As shown in FIG. 3, the molding apparatus 30 includes a mold 31, a mold-coat material injection device 50, a molding material injection device 60, and a depressurizing device 70. In the preferred embodiment, the molding apparatus 30 also includes a releasing agent injection device 80.

As shown in FIG. 4, the mold 31 is a horizontal type mold in which the parting surfaces extend horizontally. The mold 31 is arranged in a box 34, which includes a frame 32 and a cover 33. The mold 31 includes a fixed mold 35 fixed to the frame 32 and a movable mold 36 fixed to the cover 33. Furthermore, a seal member 37 extends along the cover 33 along the portion that contacts the frame 32.

In the molding apparatus 30, when the cover 33 moves upward relative to the frame 32 to separate the cover 33 from the frame 32, the parting surfaces of the movable mold 36 and the fixed mold 35 are separated from each other. This opens the mold 31. Conversely, when the cover 33 moves toward the frame 32 until the frame 32 and the cover 33 contact each other, the parting surfaces of the movable mold 36 and the fixed mold 35 come into contact with each other. This closes the mold 31. When the mold 31 is closed, a space 34a is defined in the box 34. The frame 32, the cover 33, and the seal member 37 seal the space 34a.

An annular channel 38 is formed in the parting surface of the fixed mold 35. An annular channel 39 is also formed in the parting surface of the movable mold 36 at a position corresponding to the annular channel 38 of the fixed mold 35. Radial portions 40 and 41 (refer to FIG. 3), which correspond to the spokes 13 of the steering wheel 10, respectively extend radially inward from the annular channels 38 and 39 at a plurality of locations (e.g., three locations) . When the mold 31 is closed, the annular channels 38 and 39 form a cavity 42 for forming the steering wheel 10.

An injection passage 43 is formed in the parting surface of the fixed mold 35. The injection passage 43 extends outward from the annular channel 38 and branches into three. An injection passage 44 is also formed in the parting surface of the movable mold 36 at a position corresponding to the injection passage 43 of the fixed mold 35. The injection passages 43 and 44 form a gate 45 when the mold 31 is closed. The outside of the box 34 is communicated with the cavity 42 through the gate 45 and three injection ports 46 formed in the frame 32.

An aperture 47 extends between the outer surface of the movable mold 36 and the annular channel 39. The aperture 47 is located at a position that is farthermost from the gate 45. As shown in FIG. 3, a through hole 48 extends between the outer surface of the movable mold 36 and each radial portions 41. If unnecessary, the through holes 48 may be eliminated.

In the frame 32, a fastener 49a projects upward from the center of the annular channel 38 in the fixed mold 35. A fastener 49b is also arranged in the cover 33 at positions corresponding to the fastener 49a. When the mold 31 is closed to insert mold the steering wheel 10, the fasteners 49a and 49b hold the metal core 14 at a predetermined position.

The mold-coat material injection device 50 is connected to one of the injection ports 46 of the frame 32 and injects a second liquid (cover layer material), which contains a surface material, to form the cover layer 22 in the cavity 42 (annular channel 38 of the fixed mold 35) of the mold 31. The cover layer material contains a solid component such as a mold-coat material (e.g., polyurethane having light resistant properties) or a pigment, and a solvent such as methylethyl ketone (MEK) and isopropyl alcohol (IPA).

The molding material injection device 60 is connected to one of the injection ports 46 of the frame 32 and injects internal molding material to form the internal molding layer 21 in the cavity (annular channel 38 of the fixed mold 35). The internal molding material contains, for example, polyol component and isocyanate component which produce polyurethane when reacted each other.

The depressurizing device 70 includes a vacuum pump 71 and depressurizes the space 34a of the box 34 and the cavity 42 of the mold 31 when manufacturing the steering wheel 10. The vacuum pump 71 is connected to the frame 32 by a pipe 72 and a drain 73. A valve 74 is arranged in the pipe 72 to connect and disconnect a vacuum system, which is defined between the pump 71 and the cavity 42 of the mold 31, and the atmosphere.

The releasing agent injection device 80 is connected to one of the injection ports 46 of the frame 32 and injects a first liquid containing a releasing agent and a solvent into the cavity 42 (the channel 38 of the fixed mold 35) of the mold 31 before forming the molded portion 20. Examples of the releasing agent may be a solid releasing agent, such as wax, or a liquid releasing agent, such as silicone oil. The releasing agent is dissolved, diluted, or dispersed by the solvent, such as cyclohexane. The releasing agent is applied to facilitate removal of the steering wheel 10 by preventing the steering wheel 10 from adhering to the inner wall surface of the cavity 42 of the mold 31 after molding.

The releasing agent injection device 80 has a measuring unit 81, which measures a predetermined amount of the first liquid containing the releasing agent before the first liquid is injected into the cavity 42. The measuring unit 81 includes a cylinder, which houses a piston reciprocated by the pressure of a fluid, such as air or hydraulic oil.

In the preferred embodiment, when forming a releasing agent layer on the wall surface of the cavity 42, the depressurizing device 70 depressurizes the cavity 42. This draws the solvent of the releasing agent vaporized in the cavity 42 to the depressurizing device 70. The molding apparatus 30 has a recovery device 90 to liquefy and recover the solvent drawn to the depressurizing device 70.

The recovery device 90, which is part of the depressurizing device 70, is located between the valve 74 and vacuum pump 71, as shown in FIG. 4. The recovery device 90 has a condenser 91, which cools the gas flowing inside the pipe 72, and a tank 92, which stores the solvent liquefied in the condenser 91. In the recovery device 90, the pipe 72 between the condenser 91 and the mold 31 (more specifically, the box 34) in the depressurizing device 70 functions as a collection passage through which vaporized solvent flows from the cavity 42. Furthermore, the recovery device 90 is located above the mold 31 and mixes the solvent recovered by the recovery device 90 with the first liquid. Thus, the recovery device 90 reuses the recovered solvent as the solvent of the releasing agent.

As shown in FIG. 4, a collection device 93 collects the vaporized solvent and the releasing agent that flow through the pipe 72 (collection passage) from the cavity 42. In the preferred embodiment, the collection device 93 is connected to the lower end of a pipe 72a, which extends vertically from the pipe 72.

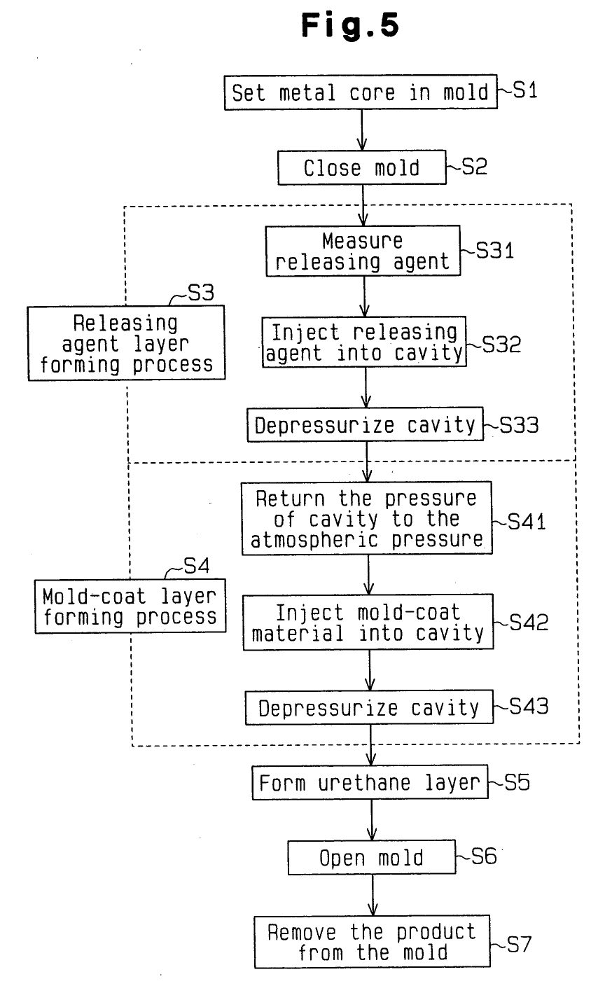

The method for manufacturing the steering wheel 10 with the molding apparatus 30 will now be described with reference to FIG. 5.

As shown in FIG. 5, first, in step S1, the metal core 14 is placed at a predetermined position relative to the open mold 31. Then, in step S2, the movable mold 36 is moved toward the fixed mold 35 to close the mold 31 (closing process).

Thereafter, in step S3, a layer of the releasing agent is formed on the wall surface of the cavity 42 of the mold 31 (releasing agent layer forming process). The releasing agent layer forming process includes the steps S3 through S33, which are described below.

First, in step S31, the measuring unit 81 uses the releasing agent injection device 80 to measure a predetermined amount of the first liquid to be injected into the cavity 42 (measuring process). Then, in step S32, the releasing agent injection device 80 injects the first liquid, which was measured by the measuring unit 81, into the cavity 42 through the gate 45 of the mold 31 (releasing agent injection process).

After the releasing agent injection process, in the subsequent step S33, in a state in which the valve 74 disconnects the vacuum system from the atmosphere, the vacuum pump 71 of the depressurizing device 70 is driven to depressurize the cavity 42 into which the first liquid had been injected (depressurizing process) . In the depressurizing process of the preferred embodiment, the cavity 42 is depressurized to boil the solvent in the first liquid at a pressure of approximately 40 kPa when using cyclohexane as the solvent. The pressure within the cavity 42 when the solvent is boiled differs depending on the manufacturing conditions of the steering wheel 10, such as the temperature of the mold 31 and the type of the solvent. In the depressurizing process, the condenser 91 of the recovery device 90 is operated.

When the depressurizing process depressurizes the cavity 42 to a predetermined pressure, the solvent in the first liquid boils within the cavity 42. The boiling of the solvent induces the first liquid to foam, such that the releasing agent contained in the first liquid adheres to the interior wall surface of the cavity 42.

The solvent is gradually vaporized, and the vaporized solvent is discharged from the cavity 42 together with gases, such as air, through the aperture 47 and the through holes 48 into the space 34a of the box 34. Then, when substantially all of the solvent in the first liquid is vaporized and the vaporized solvent has been discharged to the space 34a of the box 34, a releasing agent layer is formed with a uniform thickness on the entire wall surface of the cavity 42. The solvent vaporized and discharged into the space 34a of the box 34 thereafter flows into the pipe 72 through the drain 73 together with gases such as air.

The gas flowing in the pipe 72 is cooled when it flows through the condenser 91 of the recovery device 90. The cooling liquefies the solvent. Then, the liquefied solvent is directed to and stored in the tank 92.

Some of the releasing agent flows into the pipe 72 together with the vaporized solvent without adhering to the wall surface of the cavity 42. When such releasing agent enters the pipe 72a, which extends vertically toward the pipe 72, the releasing agent falls and is collected by the collection device 93. The releasing agent collected by the collection device 93 is mixed with the first liquid and reused. Costs are saved by reusing the collected releasing agent in this manner.

When the releasing agent layer forming process ends, the molded portion 20 is formed in steps S4 and S5 (molded portion forming process). In the molded portion forming process, first, in step S4, the mold-coat layer forming process is performed as a surface layer forming process for molding the cover layer 22. In the mold-coat layer forming process, each of the processes of steps S41 through S43 are sequentially performed.

In step S41, the valve 74 of the depressurizing device 70 is opened to the connect the vacuum system with the atmosphere (vacuum system opening process). The vacuum system opening process returns the pressure of the cavity 42 to a normal state from the depressurized state. Then, in step S42, a predetermined amount of the cover layer material (a second liquid containing surface material) is injected into the cavity 42 of the closed mold 31 through the gate 45 of the mold 31 (mold-coat material injection process, which also serves as a surface material injection process).

After the mold-coat material injection process ends, in step S43, the valve 74 is closed to disconnect the vacuum system from the atmosphere. The vacuum pump 71 of the depressurizing device 70 is driven again to depressurize the cavity 42 into which the cover layer material has been injected (depressurizing process) . In the depressurizing process of step S43, the cavity 42 is depressurized to boil the solvent in the cover layer material at a pressure of 43 kPa when methylethyl ketone or isopropyl alcohol is used as the solvent. The pressure in the cavity 42 when the solvent boils differs depending on the manufacturing conditions of the steering wheel 10, such as the temperature of the mold 31 and the type of the solvent.

When the cavity 42 is depressurized by the depressurizing process in step S43 to a predetermined pressure, the solvent in the cover layer material within the cavity 42 boils. By boiling the solvent, the cover layer material is rendered to a foam condition, and the mold-coat material and solids, such as pigments, in the cover layer material adhere to the interior wall surface of the cavity 42.

The solvent in the cover layer material is gradually vaporized, and the vaporized solvent is discharged together with gases, such as air, from the cavity 42 through the aperture 47 and the through holes 48 into the space 34a of the box 34. Then, when substantially all the solvent in the cover layer material is vaporized and the vaporized solvent is discharged to the space 34a of the box 34, the cover layer 22 is superimposed on the entire wall surface of the cavity 42 (more specifically, the releasing agent layer) with a uniform thickness. The solvent vaporized and discharged into the space 34a of the box 34 is then discharged out of the box 34 by the depressurizing device 70 together with the gases such as air.

Then, in step S5, the molding material injection device 60 injects a predetermined amount of the internal molding into the cavity 42 of the closed mold 31 through the gate 45 of the mold 31 to perform normal urethane molding (urethane layer forming process).

The urethane layer forming process forms the internal molding layer 21 in the cavity 42 between the cover layer 22, which is formed in the mold-coat layer forming process of step S4, and the outer surface of the metal core 14 (more specifically, a coating formed from the same material as the cover layer 22 adhered to the surface of the metal core 14).

After the molded portion 20 is molded, in step S6, the mold 31 is opened (opening process), and the molded steering wheel 10 is removed from the mold 31 (product removal).

The preferred embodiment has the advantages described below.

(1) In the embodiment, after the metal core 14 is set in the mold 31 in step S1 and the closing process is performed in step S2, the releasing agent layer forming process is performed in step S3. Furthermore, the releasing agent layer forming process includes a releasing agent injection process for injecting the liquid, which contains the releasing agent, into the cavity 42 of the mold 31 with the releasing agent injection device 80, and a depressurizing process for depressurizing the cavity 42 with the depressurizing device 70 when the mold 31 is closed. In the depressurizing process, the cavity 42 is depressurized to boil the solvent in the liquid, which contains the releasing agent.

When, for example, the releasing agent is sprayed with a spray gun as in the conventional art, the distribution of the releasing agent varies depending on the skill of the operator performing the work. That is, when the operator's skill is low, the releasing agent may not be adequately applied to the wall surface of the cavity 42 near the parting surfaces of the mold 31. This would result in the releasing agent being applied in an irregular manner.

In the preferred embodiment, the first liquid containing the releasing agent is foamed and thoroughly distributed throughout the cavity 42, such that the releasing agent is uniformly adhered to the entire wall surface of the cavity 42. Therefore, the releasing agent is applied in a uniform manner. As a result, the removal of the molded steering wheel 10 from the mold 31 is facilitated, and damage to the molded portion 20 when removing the steering wheel 10 from the mold 31 is suppressed.

When insert molding the steering wheel 10, the releasing agent is uniformly applied to the entire wall surface of the cavity 42 even when part of the metal core 14 is exposed in the cavity 42 since the releasing agent layer forming process is performed after the metal core 14 is set in the mold 31 and the mold 31 is closed.

The releasing agent is applied to the wall surface of the cavity 42 when the mold 31 is in a closed state. This suppresses the application of the releasing agent on the parting surfaces of the mold 31 and the inclusion of the releasing agent accumulated on the parting surfaces in the molded portion 20, which would occur when applying the releasing agent with a spray gun. As a result, the production of residual releasing agent in the molded portion 20 of the steering wheel 10, or the so-called notching of the releasing agent notching, is suppressed.

As a result, the steering wheel 10, which is required to be aesthetic since it is visible to the passenger and touched by the driver, has high quality.

In comparison to when using a spray gun to apply the releasing agent, the amount of releasing agent applied to areas other than the wall surface of the cavity 42 is reduced. This improves the releasing agent application efficiency. Further, the releasing agent is not dispersed to the surrounding of the mold 31. This improves the working environment.

(2) In the releasing agent layer forming process, the depressurizing process is performed after the releasing agent injection process ends. In this way, the cavity 42 is depressurized with the first liquid containing the releasing agent completely distributed to the vicinity of the aperture 47 in the cavity 42. Therefore, non-uniform application of the releasing agent, which would occur if the solvent of the first liquid vaporizes before the first liquid reaches the vicinity of the aperture 47 in the cavity 42, is suppressed.

(3) In the releasing agent layer forming process, the solvent vaporized in the cavity 42 during the depressurizing process is recovered by the recovery device 90, and the recovered solvent is reused as the solvent of the releasing agent. Therefore, discharge of the vaporized solvent into the atmosphere is suppressed. Furthermore, since the vaporized solvent is reused, costs are reduced.

(4) The recovery device 90 is located at a higher position than the mold 31. This makes it difficult for the solvent vaporized in the depressurizing process of the releasing agent layer forming process and the releasing agent discharged from the box 34 into the depressurizing device 70 to move upward within the pipe 72 due to the force of gravity. Therefore, the releasing agent flowing into the depressurizing device 70 is suppressed from flowing into the recovery device 90.

(5) The collection device 93 is located at the lower end of the pipe 72a of the depressurizing device 70. This collects the solvent vaporized in the depressurizing process and the releasing agent discharged from the cavity 42 into the depressurizing device 70 in the collection device 93. Therefore, the amount of releasing agent flowing into the recovery device 90 and vacuum pump 71 is reduced, and the depressurizing device 70 and the recovery device 90 can be ensured of maintaining high performance over a long period. Furthermore, it becomes difficult for the releasing agent to be discharged out of the molding apparatus 30 by the vacuum pump 71 and prevents the releasing agent from being dispersed to equipment surrounding the molding apparatus 30. This improves the work environment.

(6) In the mold-coat layer forming process, the cover layer material is injected into the cavity 42 of the mold 31 with the mold-coat material injection device 50. Then, with the mold in a closed state, the depressurizing device 70 depressurizes the cavity 42. This prevents the cover layer material from being applied in a non-uniform manner and uniformly applies the mold-coat material and solids such as pigments to the entire wall surface of the cavity 42.

In the mold-coat material injection process, the cover layer material is injected into the cavity 42 of the mold 31 when the mold is in the closed. Therefore, during the time from the closing process in step S2 to the release process in step S6, the steering wheel 10 is manufactured with the mold 31 kept in the closed state. This reduces the manufacturing time of the steering wheel 10.

(7) A member having a U-shaped cross section and a concave channel 14a corresponding to the ring 11 of the steering wheel 10 is used as the metal core 14. Therefore, the steering wheel 10 is molded in a state wherein the internal molding layer 21 has a concavo-convex engagement relationship with the concave channel 14a of the metal core 14. In this way, rotation of the internal molding layer 21 by the turning of the ring 11 of the metal core 14 is suppressed even if the adhesion between the internal molding layer 21 and the ring 11 of the metal core 14 is low.

It should be apparent to those skilled in the art that the present invention may be embodied in many other specific forms without departing from the spirit or scope of the invention. Particularly, it should be understood that the present invention may be embodied in the following forms.

In the preferred embodiment, the measuring process (step S31) starts after the closing process (step S2) ends. However, the measuring process may be started before the closing process, at the same time as when starting the closing process, or during the closing process.

In the preferred embodiment, the releasing agent injection process (step S32) starts after the measuring process (step S31) ends. However, the releasing agent injection process may start at the same time as when starting the measuring process or during the measuring process.

When measuring the first liquid, the releasing agent injection process may start before starting the closing process (step S2), at the same time as when starting the closing process, or during the closing process.

In the preferred embodiment, the depressurizing process (step S33) starts after the releasing agent injection process (step S32) ends. However, the depressurizing process may start immediately before the releasing agent injection process ends. In this case, in the releasing agent injection process, the cavity 42 is depressurized to a predetermined pressure when the first liquid containing the releasing agent has been delivered to the vicinity of the aperture 47 in the cavity 42.

After the closing process (step S2), the releasing agent injection process may be performed at the same time as when starting the depressurizing process or the releasing agent injection process may be performed as the cavity 42 is depressurized in the depressurizing process. In such cases, the injection of the releasing agent into the cavity 42 is accelerated, and the manufacturing time of the steering wheel 10 is reduced. In order to form the releasing agent layer over the entire wall surface of the cavity 42, it is desirable that the pressure of the cavity 42 is maintained within a range in which the solvent in the first liquid does not boil when the first liquid is injected and that the cavity 42 is depressurized to a pressure at which the solvent will boil immediately before the first liquid injection is completed or after the first liquid injection is completed.

In the measuring process (step S31), the measurement of the first liquid containing the releasing agent may be performed, for example, using a measuring cup. In this case, after measurement, the first liquid may be injected into the channel 38 of the opened fixed mold 35, or supplied to the releasing agent injection device 80. In the latter case, the measuring unit 81 of the releasing agent injection device 80 may be eliminated.

When manufacturing a steering wheel which does not have the cover layer 22, such as a leather-wrapped steering wheel, the mold-coat layer forming process of step S4 may be eliminated. In this case, the mold-coat material injection device 50 of the molding apparatus 30 may be eliminated.

A vertical-type mold 31 having parting surfaces extending vertically may be used. In this case, the first liquid must be injected into the cavity 42 when the mold is closed in order to prevent the first liquid from flowing out of the cavity 42.

The depressurizing device 70, which operates during the depressurizing process of the releasing agent layer forming process (step S3), and a further depressurizing device, which operates during the depressurizing process of the mold-coat layer forming process (step S4), may be separately connected to the box 34. In this case, the solvent of the cover layer material is prevented from mixing with the solvent recovered by the recovery device 90.

The recovery device 90 may be operated during the depressurizing process of the releasing agent layer forming process (step S3). In this case, the tank 92 for storing the solvent in the first liquid and a further tank for storing the solvent in the cover layer material may be provided separately, and the flow passage from the condenser 91 may be switched to from either one of the tanks each time the depressurizing process is performed.

The collection device 93 may be provided with a filter located, for example, between the box 34 and the condenser 91 or at the inlet to the vacuum pump 71.

The collection device 93 may be omitted when the releasing agent does not flow into the depressurizing device 70 during the depressurizing process of the releasing agent layer forming process (step S3).

The recovery device 90 need not be located at a position higher than the mold 31, for example, when the pipe 72 is U-shaped, when the collection device 93 is provided between the box 34 and the condenser 91, or when it is difficult for the releasing agent to reach the condenser 91.

The recovery device 90 may be eliminated.

The cross section shape of the part of the metal core 14 corresponding to the ring 11 of the steering wheel 10 is not limited to the U-shape. The cross section may have any shape, for example, a J-shape, C-shape, H-shape, I-shape, T-shape, L-shape, or a sideways U-shape as long as the metal core 14 has a concavity or a convexity at least partially in the portion corresponding to the ring 11 of the steering wheel 10.

The preferred embodiment is a method for manufacturing the steering wheel 10. However, the present invention may be applied to the molding of insert molded products and molded products which do not have an insert member other than the steering wheel 10, such as an assist grip. Essentially, the present invention may be applied to a method for manufacturing a molded product that performs a releasing agent layer forming process, which forms a releasing agent layer on a cavity wall, before a molded portion forming process, which forms a molded portion from a molded material in a mold cavity.

The present examples and embodiments are to be considered as illustrative and not restrictive, and the invention is not to be limited to the details given herein, but may be modified within the scope and equivalence of the appended claims.

What is claimed is:

1. A method for manufacturing a molded product having a molded portion, the method comprising:
forming a releasing agent layer on a wall surface of a cavity of a mold by injecting a first liquid containing a releasing agent into the cavity and depressurizing the cavity; and
forming the molded portion by supplying a molding material into the cavity after the releasing agent layer is formed.

2. The method of claim 1, wherein the depressurization of the cavity is performed immediately before the injection of the releasing agent ends or after the injection of the releasing agent ends.

3. The method of claim 1, wherein the releasing agent is injected when depressurizing the cavity.

4. The method of claim 1, wherein the injection of a first liquid and the depressurization of the cavity are performed when the mold is closed.

5. The method of claim 1, wherein the first liquid includes the releasing agent and a solvent, and the cavity is depressurized to a pressure at which the solvent boils.

6. The method of claim 5, further comprising:
recovering the solvent vaporized in the cavity when the cavity is depressurized; and
reusing the recovered solvent as the solvent of the releasing agent.

7. The method of claim 6, further comprising:
collecting the releasing agent discharged from the cavity.

8. The method of claim 6, wherein the solvent is recovered by a recovery device arranged at a higher position than the mold.

9. The method of claim 8, wherein the releasing agent is collected by a collection device arranged in a recovery passage connecting the recovery device and the mold.

10. The method of claim 1, wherein the molded product has a surface layer on at least part of its surface, the method further comprising:
superimposing the surface layer on the releasing agent layer formed on the wall surface of the cavity by injecting a second liquid containing material of the surface layer into the cavity and depressurizing the cavity.

11. The method of claim 1, wherein the molded product is an insert molded product including an insert member occupying at least part of the molded product.

12. The method of claim 11, further comprising:
arranging the insert member in the cavity before forming the releasing agent layer.

13. The method of claim 11, wherein the insert molded product is a vehicle steering wheel, and the insert member is a metal core.

14. The method of claim 13, wherein the metal core has a convexity or a concavity in at least part of a portion corresponding to a grip of the vehicle steering wheel.

15. The method of claim 1, wherein the injection of the first liquid includes injecting a previously measured amount of the first liquid into the cavity.

16. A method for manufacturing a molded product using a mold having a cavity, the method comprising the steps of:
forming a releasing agent layer on entire surface of the cavity when the mold is closed; and
supplying molding material to the cavity after the releasing agent layer is formed to form the molded product.

17. The method of claim 16, wherein the step of forming a releasing agent layer includes the steps of:
closing the mold;
injecting a first liquid including a releasing agent and a solvent that vaporizes under a reduced pressure into the cavity; and
depressurizing the cavity to a pressure at which the solvent vaporizes.

18. The method of claim 17, wherein the step of injecting a first liquid includes injecting a previously measured amount of the first liquid.

19. The method of claim 18, further comprising the steps of:
recovering the solvent vaporized in the cavity when the cavity is depressurized; and
reusing the recovered solvent as the solvent of the releasing agent.

20. The method of claim 17, wherein the molded product has a surface layer on at least part of its surface, the method further comprising the step of:
superimposing the surface layer on the releasing agent layer formed on the surface of the cavity by injecting a second liquid containing material for forming the surface layer into the cavity and depressurizing the cavity.
